(19) United States
(12) Patent Application Publication
(10) Pub. No.: US 2010/0053211 A1
(43) Pub. Date: Mar. 4, 2010

(54) User interface method and system with image viewer for management and control of automated image processing in high content screening or high throughput screening

(75) Inventors: Randall S. Ingermanson, Battleground, WA (US); Jeffrey M. Hilton, San Diego, CA (US)

Correspondence Address: TERRANCE A. MEADOR;INCAPLAW, 1050 ROSCRANS STREET, SUITE K, SAN DIEGO, CA, 92106, US

(73) Assignee: Vala Sciences, Inc., San Diego, CA (US)

(21) Appl. No.: 12/459,146

(22) Filed: Jun. 26, 2009

Related U.S. Application Data
(63) Continuation-in-part of application No. 12/454,081, filed on May 12, 2009.
(60) Provisional application No. 61/133,277, filed on Jun. 27, 2008.

(51) Int. Cl. G09G 5/00; G06F 3/048

(52) U.S. Cl. 345/626; 715/843; 345/628

(57) ABSTRACT

A user interface method and system for controlling automated image processing operations of HCS and/or HTS systems includes a graphical interface to enable user designation of an image naming convention, image sources and destinations, image processing channels, processing parameter values, and processing spatial designations. The graphical interface includes an image viewer.

### PRIORITY

This application claims priority to U.S. Provisional Application for Patent 61/133,277, filed Jun. 27, 2008. This application is a continuation-in-part of pending, commonly-owned U.S. patent application Ser. No. 12/454,081, filed May 12, 2009.

### RELATED APPLICATIONS

The following applications contain subject matter related to this application.

U.S. patent application Ser. No. 11/285,691, filed Nov. 21, 2005 for “System, Method, And Kit For Processing A Magnified Image Of Biological Material To Identify Components Of A Biological Object”;

PCT application PCT/US2006/044936, filed Nov. 17, 2006 for “System, Method, And Kit For Processing A Magnified Image Of Biological Material To Identify Components Of A Biological Object”, published as WO 2007/061971 on May 31, 2007;

U.S. patent application Ser. No. 12/454,081, filed May 12, 2009 for “User Interface Method And System For Management And Control Of Automated Image Processing In Image Content Screening”; and,

U.S. patent application Ser. No. 12/454,217, filed May 13, 2009 for “Automated Transient Image Cytometry”.

### STATEMENT OF GOVERNMENT INTEREST

The inventions described herein were made in part with government support under Grant No. 1R43DK074333-01, Grant No. 1R41DK076510-01, and Grant No. 1R42HL086076, all awarded by the National Institutes of Health. The United States Government has certain rights in the invention.

The technical field concerns high content screening (HCS) and/or high throughput screening (HTS) using an automated image processing system capable of detecting and measuring one or more components of one or more objects in a magnified image of biological material. More particularly, the technical field includes such an automated image processing system with an image viewer that enables a user to retrieve and view original and processed images in order to evaluate and adjust image processing algorithm parameter values.

HCS and/or HTS, an automated image processing system obtains images from an automated microscope and subjects those images to processing methods that are specially designed to detect and measure small components of biological material. The processing methods employ algorithms customized to respond to markings, such as colors, and to detect particular image characteristics, such as shapes, so as to quickly and reliably identify components or features of interest. Based upon the identification, the system then makes spatial and quantitative measurements useful in analysis of experimental results. This process is frequently referred to as an assay, a quantitative and/or qualitative assessment of an analyte. Automated image processing systems are increasingly used as assay tools to determine, measure, and analyze the results of tests directed to development or evaluation of drugs and biological agents.

Related U.S. patent application Ser. No. 11/285,691 describes an automated microscopy system with image processing functions that is capable of performing high content screening. The system distinguishes densely packed shapes in cellular and subcellular structures that have been activated in some way. Components such as membranes, nuclei, lipid droplets, molecules, and so on, are identified using image processing algorithms of the system that are customized to detect the shapes of such components. U.S. patent application Ser. No. 11/285,691 is incorporated herein by reference

Presently, HCS and/or HTS systems quickly acquire and process large numbers of magnified microscopic images and produce significant quantities of information. Substantial attention and time are required from a user to efficiently manage and accurately control the automated image processing operations. Consequently, there is a need to provide tools that enhance user efficiency and convenience, while reducing the time spent and errors encountered in controlling the image processing operations of HCS and/or HTS systems.

For reasons of speed and the ability to acquire and process enormous amounts of information, automated image processing is significantly challenging the conventional tools currently used for HCS/HTS. However, there is an urgent need to increase the accessibility, efficiency, accuracy and effectiveness of automated image processing in order to inspire the user confidence necessary to its widespread adoption as the HCS/HTS analytical procedure of choice. In this regard, substantial progress has been made in developing combinations or sets of reagents and algorithms for acquiring and processing microscopic images of biological material, and quantitative tools have been adapted and/or developed for extracting and analyzing information from the processed images.

It is frequently the case, however, that one or more iterations of image processing are required in order to adjust algorithm settings so as to have the information analysis be as accurate as possible. A very useful image handling tool would provide fast and convenient access for specifying and viewing microscopic images that have been acquired and processed. The ability to view both original and processed images after an assay enables a user to make decisions whether to set, reset, adjust, or otherwise change image processing algorithm parameter values so as to vary or affect the quality of results obtained by extraction and analysis of information from the processed images.

### SUMMARY

A user interface method and system for controlling automated image processing operations of HCS and/or HTS systems includes a graphical interface operative to designate an image naming convention, image sources and destinations, image processing channels, processing parameter values, and processing spatial designations.

Preferably, the graphical interface includes an image viewer operative to retrieve and view original acquired and processed images in order to observe the effects of image processing algorithm parameter values.

### BRIEF DESCRIPTION OF THE DRAWINGS

FIG. 1 illustrates how objects in cells are visualized for multiple processing channels by an automated image processing system.

FIG. 2 illustrates quantification of induction of IL-8 messenger RNA in response to concentration of a reagent.

FIG. 3 illustrates an image naming convention.

FIG. 4 illustrates a first graphical user interface (GUI) useful for management and control of automated image processing.

FIG. 5 illustrates the GUI of FIG. 4 following selection of an image naming convention.

FIG. 6 illustrates an image process performed by an automated image processing system to generate a mask from an acquired image.

FIG. 7 illustrates data files used to manage experimental data produced by an automated image processing system.

FIG. 8 illustrates a data table format used to store experimental data.

FIG. 9 illustrates an image process performed by an automated image processing system to generate experimental data from an acquired image.

FIG. 10 illustrates two additional data table formats used to store experimental data.

FIG. 11 illustrates two additional data table formats used to store experimental data.

FIG. 12 illustrates models of experimental results produced from experimental data.

FIG. 13 shows sample images obtained through a nuclear channel for different nuclear size values of a Nuclear Size setting of the GUI of FIG. 4.

FIG. 14 shows sample images obtained through the nuclear channel for different nuclear size values of a Nuclear threshold setting of the GUI of FIG. 4.

FIG. 15 shows sample images obtained through the RNA channel for different values of the RNA threshold setting of the GUI of FIG. 4.

FIG. 16 illustrates a second GUI useful for management and control of automated image processing

FIG. 17 illustrates a View pull-down in the second GUI that provides access to an image viewer.

FIG. 18 illustrates a Set Images dialog box that provides interactive access to image access functions of the image viewer.

FIG. 19 illustrates a main imager viewer window through which the image viewer displays images.

FIGS. 20A-20E illustrate image display functions of the image viewer.

FIG. 21 illustrates a composite image displayed through the main imager viewer window.

FIG. 22 is a block diagram of an automated system for obtaining and processing images of biological material and for analyzing processed images.

FIG. 23 is a block diagram showing a processing architecture including the second GUI and the image viewer.

FIG. 24 illustrates a tangible medium of storage to store a set of software instructions that enable an automated image processing system to operate according to a method.

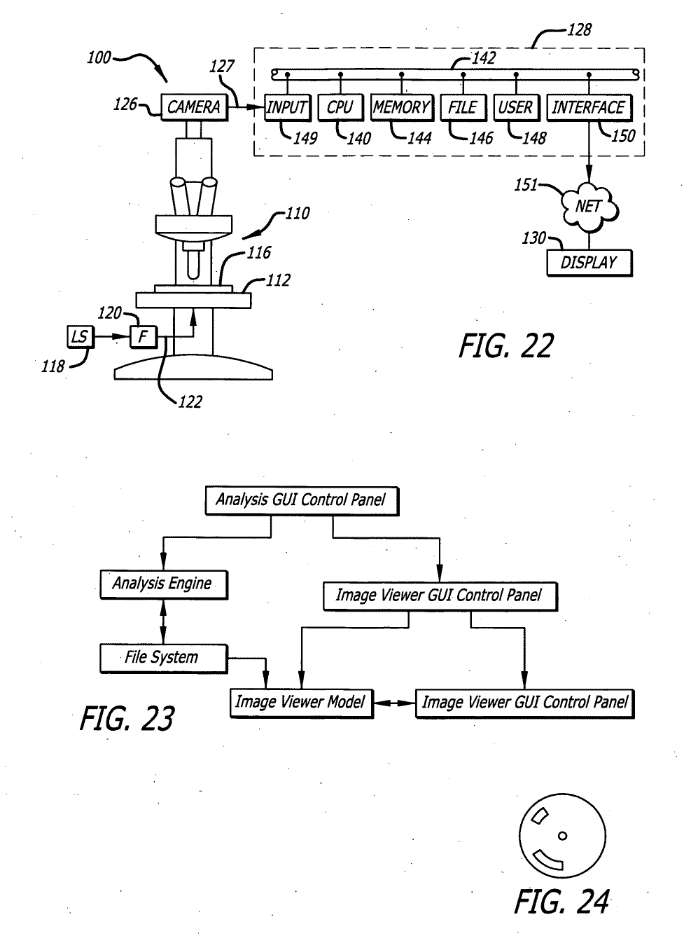

### DETAILED DESCRIPTION OF A GRAPHICAL USER INTERFACE

As will be evident, it is desirable to apply the principles of this description broadly to control of image processing algorithms tailored to many and varied analysis tasks in processing systems that process image data to analyze, screen, identify, and/or classify image features, objects, and/or contents. It is particularly desirable to afford a user the ability to prepare image data for processing, to selectively control modes and parameters of processing the image data, to view results produced by processing the image data, and to selectively step through successive cycles of image data processing in order to adjust results.

In this description, a specific biological process—transcription—is used to illustrate a user interface method and system for automated image processing in HCS or HTS. The example is intended to illustrate how a user can manage and control execution of an image processing algorithm selected to process microscopic images of biological material in order to analyze features of the material affected by a biological assay. This example is not intended to limit the application of the principles of the user method and system only to transcription. Nevertheless, with the example, the reasonably skilled person will be able to apply the principles broadly to control of image processing algorithms tailored to many and varied analysis tasks in HCS and/or HTS systems.

All gene expression begins with transcription, the process by which messenger RNAs are transcribed from the genome. In transcription, messenger RNA (mRNA) is synthesized in a cell under control of DNA. The process copies a DNA sequence into a cell using mRNA. The copied sequence is in fact a strand of RNA in the cell. The number of mRNA copies present in a cell transcribed from a single gene can vary from 0 to >1000, as transcription is heavily regulated during cell differentiation or responses of the cells to hormones, drugs, or disease states.

Through use of inexpensive reagents and simple protocols, a transcription assay can be conducted in which mRNA is and then captured. The location and number of individual mRNA species captured can be visualized in cells and tissue sections by fluorescence-based detection and quantified by automated image processing.

For visualization in images, a probe is used which binds to target mRNA species with very high specificity. It is possible to generate probes to virtually any known sequence. Preferably, such probes are hybridized to the target mRNAs in cell or tissue samples that have been fixed and permeabilized. A fluorescent reagent, may then added, which binds to the probe. When slides and well plates containing cultured cells are processed in this manner, and viewed with fluorescence microscopy, bright spots (mRNA loci) are apparent that correspond to individual copies of the target mRNA.

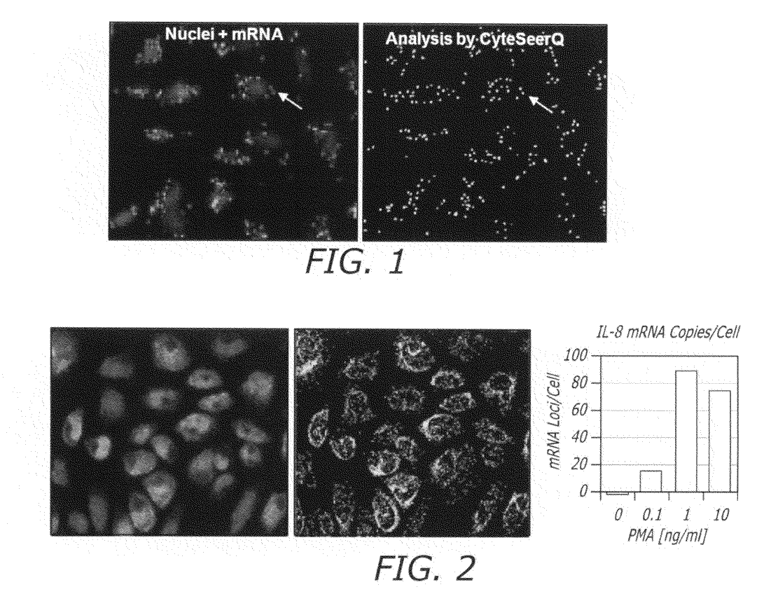

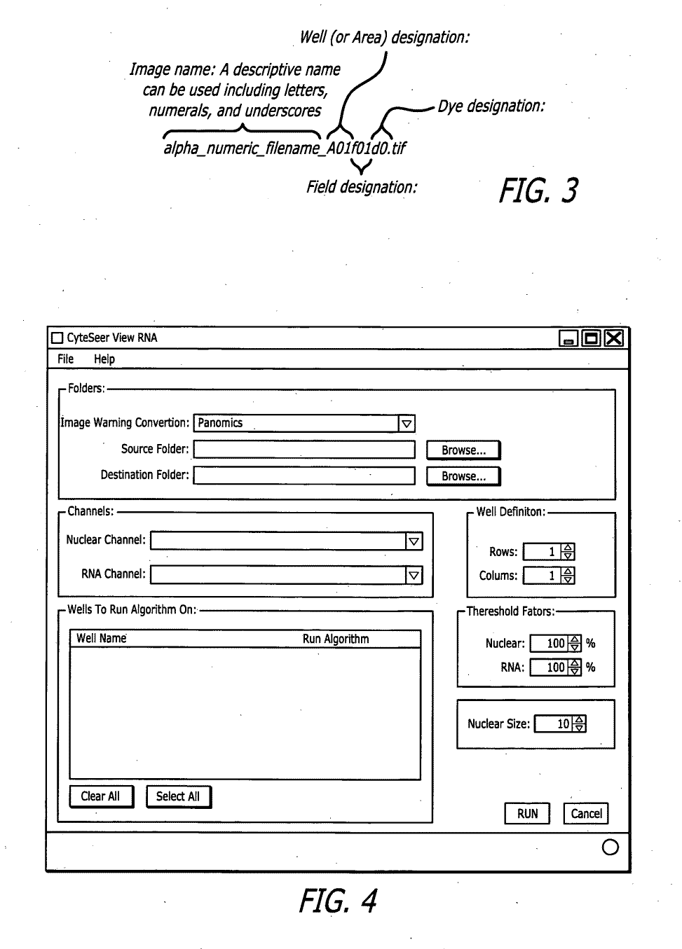

Visual representations of these operations are presented in FIGS. 1 and 2. However, these are only meant to illustrate how an automated image processing system operates. The panels of these figures are colored for convenience and ease of understanding. In fact, the image acquisition and processing operations of an automated image processing system are conducted on grey scale images that are acquired from stained samples via filtered imaging.

To quantify gene transcription, the mRNA loci can be individually counted for each cell. While this can be done manually, by loading such images in a general purpose image analysis program, manual analysis is very laborious and time consuming due to fatigue and inconsistency between researchers. A convenient, user-friendly, and accurate alternative may be provided by an image processing algorithm, which may be in the form of a Windows® compatible, Java-based software system, specifically engineered for this application. With reference to FIG. 1, for example, such a system identifies individual cells, and quantifies the number of mRNA loci on a per cell basis in fields of view imaged for nuclei (shown in blue with DAPI staining), and for mRNA (shown in green using fluorescent reagents). Results produced by such a system may be input into a quantitative modeling system (such as a spreadsheet process) in order to organize, quantify, model, and present the results for interpretation and analysis.

FIG. 2 illustrates the performance of an mRNA assay and quantification by an image processing algorithm in an experimental setting, using a Quantigene® reagent set available from Panomics, Inc., Fremont, Calif. and an automated image processing system available from Vala Sciences, Inc. In this assay, cells were exposed to different concentrations of phorbol 12-myristate 13-acetate (PMA), and analyzed for the copy number of IL-8 mRNA. For control cells (exposed to 0 PMA), essentially no IL-8 mRNA were detected (0.05/cell). In contrast, exposure to PMA led to a dramatic increase in the presence of the loci with an EC50 of between 0.1 and 1 ng/ml PMA. The left panel of FIG. 2 shows visualization of nuclei (blue) and mRNA (green) in cells exposed to 1 ng/ml PMA; the middle panel shows how an automated image processing system based on related U.S. patent application Ser. No. 11/285,691 identifies mRNA loci (green); and the right panel is a bar chart produced by quantitative modeling of data obtained from the images of the left and right hand panels. The right panel of FIG. 2 shows a dose-response relationship for induction of mRNA by PMA; each bar in the chart represents a mean of 67 to 100 cells.

A user interface method for management and control of automated image processing in high content screening or high throughput screening is now set forth. Although useful for a single image processing algorithm, the explanation presumes the installation and operation of an automated image processing system with a set, group, family, or library of image processing algorithms from which a user may select an algorithm for performing a specific task such as visualization and detection of mRNA loci. Such a system may be based on, for example, the system set forth in related U.S. patent application Ser. No. 11/285,691. The automated image processing system is installed on or in computer, web, network, and/or equivalent processing resources that include or execute cooperatively with other processes, including data and file management and quantitative modeling processes. The method includes some or all of the following acts.

1. Initially, an assay sample to be visualized is prepared. The sample may be, for example, cells on a tissue slide, a coverslip or in optically clear multiwall dishes.

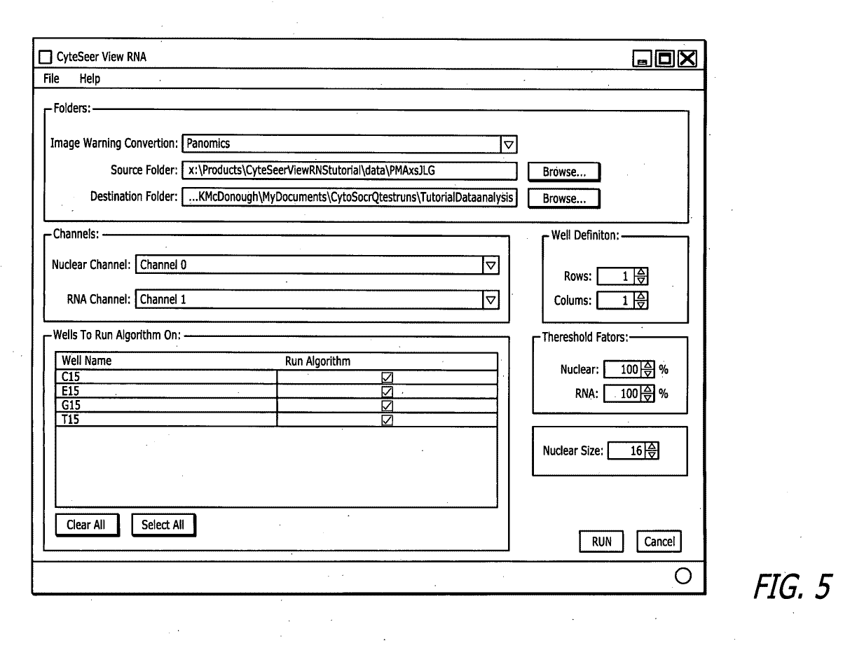

2. The automated image processing system is launched and the system acquires images of the sample. For the example mRNA assay described above, such images may include images represented by those of the left panels of FIGS. 1 and 2. At each image location (well or slide area) the system obtains a grey scale image of nuclei (using a blue filter if nuclei are stained with blue dye) and a grayscale image of mRNA (using a green filter if mRNA strands are colored with a green probe). As they are acquired, the images are placed in a file system storage structure, for example a folder, by the automated image processing system. Preferably, each image has a tag appended to it by the automated image processing system. The tag may be called a “name”. Preferably, the automated image processing system observes and implements at least one, and preferably two or more image naming conventions. Preferably, the automated image processing system receives a command entered by the user as to which naming convention to use when acquiring images. One such naming convention is illustrated in FIG. 3. In the example of FIG. 3, the naming convention includes an alphanumeric image name followed by a designation of a well or a slide area at which the image was obtained, a field designation, and a channel designation. The field designation indicates a field of the designated well or slide area where the image was obtained. The channel designation indicates a processing channel that corresponds to some component of an object in the image. There may be one, two, or more, channels defined for a set of images obtained from an assay. Components that correspond to respective channels may include, for example cell membrane, cell nucleus, lipid droplet, mRNA strand, etc. Thus, with respect to the illustrative mRNA assay example, a “nuclear channel” may correspond to cell nuclei, and an “RNA channel” to RNA dots.

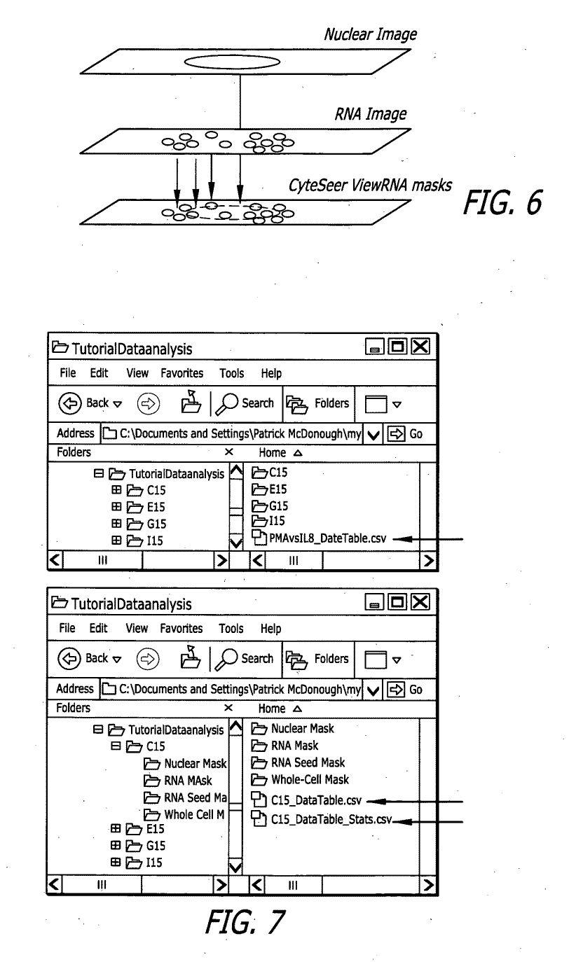

3. When a set of images has been obtained, named, and placed in a folder by the automated image processing system, an image processing algorithm is launched to obtain assay results from the images. The launch initially causes the graphical user interface (GUI) screen shown in FIG. 4 to be displayed. The screen enables the user to manage and control the automated image processing performed by the algorithm.

4. Using the GUI screen of FIG. 4, the user chooses an image naming convention by way of the drop-down menu entitled “Image Naming Convention”.

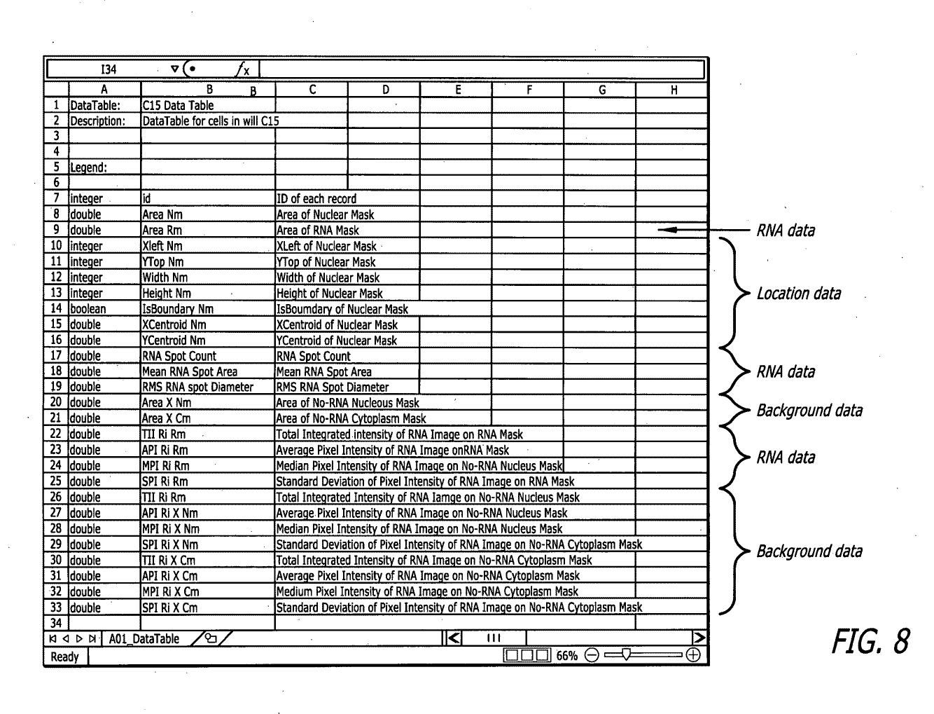

5. Using the GUI screen of FIG. 4, the user chooses a source folder containing images to be processed by way of the drop-down menu entitled “Source Folder”. For convenience, the user may browse to a source folder with images containing images tagged according to the selected image naming convention by way of the browse button to the right of the “Source Folder” drop-down menu. This choice will cause the “Wells To Run Algorithm On” field to populate, displaying the well or slide area names of files. The result is shown in FIG. 5.

6. Using the GUI screen of FIG. 4, the user chooses a destination folder. Preferably, the automated image processing will generate reference “mask” images and *.csv files (Excel compatible) and place these files in the folder designated here. The destination folder may be found or created using the “Destination Folder” drop-down menu and the browse button to the right of it. The resulting choice is shown in FIG. 5.

7. Using the GUI screen of FIG. 4, the user associates image characteristics with two or more system-named channels for the automated image processing to be conducted. With the illustrated example, the user may associate a first color cannel (blue as channel 0, for example) with a nuclear channel and a second color (green as channel 1, for example) with an RNA channel. The choices designate respective nuclear and mRNA loci process streams in the image processing algorithm. The resulting choices are shown in FIG. 5.

8. Using the GUI screen of FIG. 4, the user establishes a well definition for a number of fields in a “Well Definition” control box. That is, the user indicates the number of fields to be processed in each well (or slide area). Thus, if there is one field (one image) per well, the user defines a single-field matrix on each well by setting both row and column indications to “1”. If 4 images are collected per well (or area) the user may designate 1 row by 4 columns, 2 rows by 2 columns, or 4 columns by 1 row. The images are analyzed independently by the automated image processing system. The resulting choices shown in FIG. 5 imply that only one image is obtained at each well or slide area.

9. Using the GUI screen of FIG. 4, the user establishes threshold parameter values for the channels in a “Threshold Factor” control box. That is, the user indicates a level of sensitivity to be observed by the selected image processing algorithm for each channel. In the illustrated example, the thresholds for the nuclear and RNA channels are set to 100%, which may be a default setting. Generally, as the threshold decreases, the sensitivity increase and dimmer objects will be identified for inclusion in processing operations. The resulting choices are shown in FIG. 5.

10. Using the GUI screen of FIG. 4, the user establishes nuclear size parameter value for the nuclear channel in a “Nuclear Size” control box. That is, the user indicates a level of sensitivity to be observed by the selected image processing algorithm for the size of objects in the nuclear channel. The size selected depends on the cell type and magnification used in acquiring the images. The objective is to reduce instances where the selected algorithm will incorrectly separate a large object into two smaller objects. The resulting choice is shown in FIG. 5.

11. Using the GUI screen as per FIG. 5, the user selects the wells (or slide areas) whose images will be processed by the selected algorithm. That is, the GUI screen lists in the “Well Name” column all of the wells from which images have been acquired, and presents in the “Run Algorithm” column a box for each named well that the user can click to cause the algorithm to process the image or images acquired from that well.

12. Using the GUI screen as per FIG. 5, the user commands the algorithm to execute according to the entries on the screen, by activating the Run button, for example. In response, the automated image processing system accesses the source folder in a predetermined sequence, subjects the acquired images in the source folder to the selected algorithm, and generates results including images or masks such as those showing the green mRNA loci in FIGS. 1 and 2. The masks or images generated are named and stored as image files in the results folder. Using loci information in the images or masks produced, the automated image processing system extracts quantitative data.

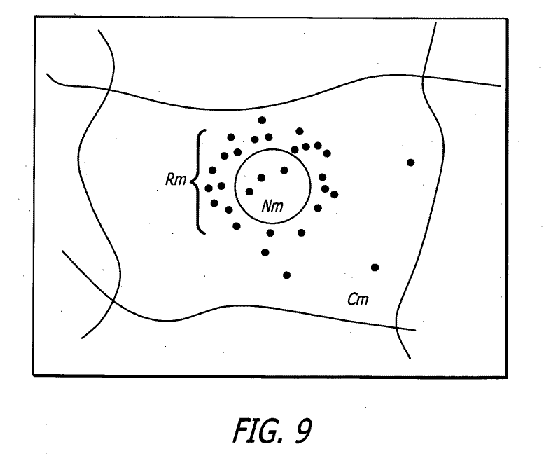

FIG. 6 illustrates in a general way how an image processing algorithm may operate to obtain results from images in the source folder. An example of one such algorithm designed for processing images of mRNA transcription is the CyteSeer™-ViewRNA process. This algorithm starts with a nuclear image (such as those in the left panels of FIGS. 1 and 2), and identifies all of the nuclei within the field of view. A nuclear mask for each cell is established. The mask contains all of the pixel locations identified as nuclear for a given cell; recall that these pixels would be blue pixels according to the mRNA example discussed above. The algorithm estimates cell boundaries and then analyzes the mRNA image, and the brightest pixels, which correspond to the mRNA spots are assigned to the mRNA mask per the left panel in FIG. 1 and the middle panel in FIG. 2. One or more sets of experimental data may then calculated by the automated image processing system, on a per cell basis, using the result images or masks. Preferably, these experimental data are presented and arranged according to a file convention and are placed into one or more files that can be transported, loaded, or otherwise made available to a quantitative modeling system (for example, a spreadsheet process).

Using well-known Excel spread sheet processing, the mRNA assay described above, and the CyteSeer™-ViewRNA algorithm available from Vala Sciences, Inc., examples of experimental data processing, handling, and storage are now described.

### File Examples

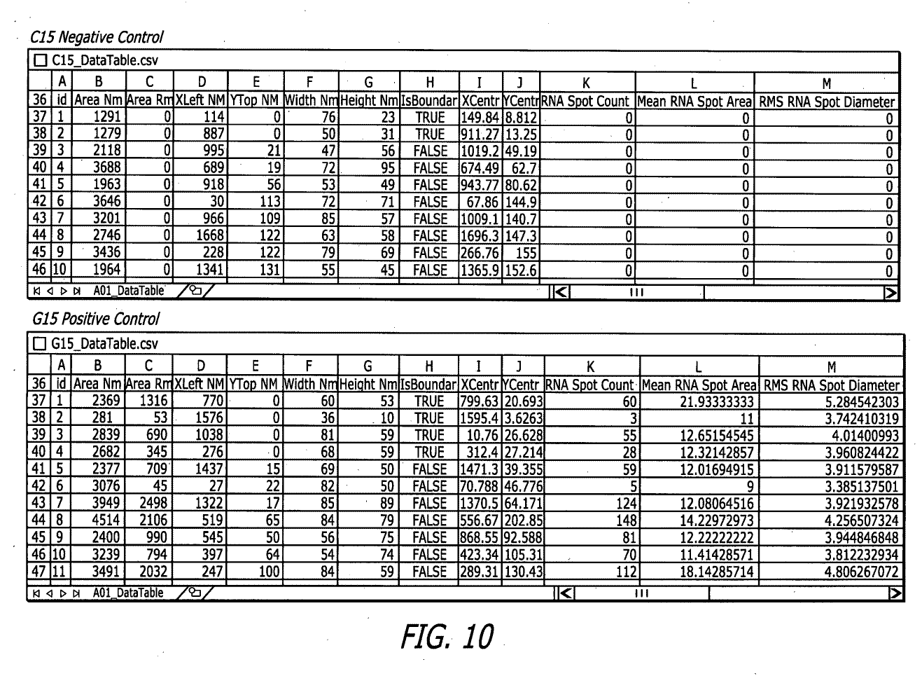

The CyteSeer™-ViewRNA creates data files in the *.csv (comma separated value) format that can be loaded easily into the well-known Excel spreadsheet system. A file that represents a summary for an experimental data set is created and is placed at a first level within the Destination folder. One example is the PMAvsIL8_DataTable.csv shown in the upper panel of FIG. 7. Additionally, two data files are created within a subdirectory for each selected well. The wellname_DataTable.csv file (e.g., C15_DataTable.csv in FIG. 7, lower panel) contains a cell by cell data readout for every cell analyzed for the well (or slide area). A Well_name DataTable_Stats.csv file contains summary statistics for a selected well. For example, C15_DataTable_Stats.csv in FIG. 7, lower panel, contains summary statistics for well C15, selected as described above.

### Data Table Examples

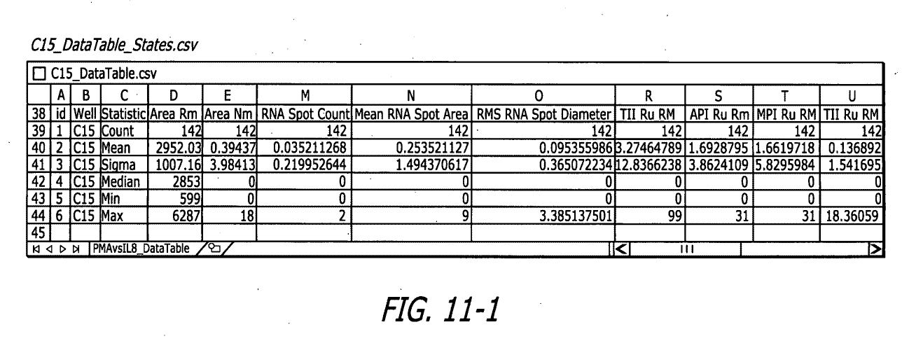

The experimental data may be stored in tables, such as the tables referenced in the files described above, and may be provided therein to a quantitative modeling system for further processing. One example of a table containing experimental data for use by an Excel spreadsheet process is seen in FIG. 8. In this example, a user would launch an Excel spreadsheet process and use the Excel open command to open the C15_DataTable.csv file shown in FIG. 8. It may be necessary to select “All Files” in the “Files of type” field within the Open menu of Excel to view and select csv files. In response, the Excel spreadsheet process will automatically open a “workbook”—style interface and the spreadsheet cells will range from Excel addresses A1 to AA178 for C15_DataTable.csv. Note that a description of the file is automatically generated and displayed in Excel addresses A1 to B2 (e.g., Data Table: C15 Data Table. Description: Data Table for cells in well C15), and the Legend portion of the file extends from A5 to C3. A7 to A33 indicate the data type of each parameter (integer, double precision, or Boolean). B7 to B33 contain short descriptions, which are also the column headers for the data displayed in the Data Table portion of spreadsheet (A36 to AA178 for C15_DataTable.csv). C7 to C33 contain brief descriptions of each data parameter. The “id” label (Excel address B7) is the header for column A in the Data Table; this is an integer number that is uniquely assigned to each cell in the image corresponding to well C15.

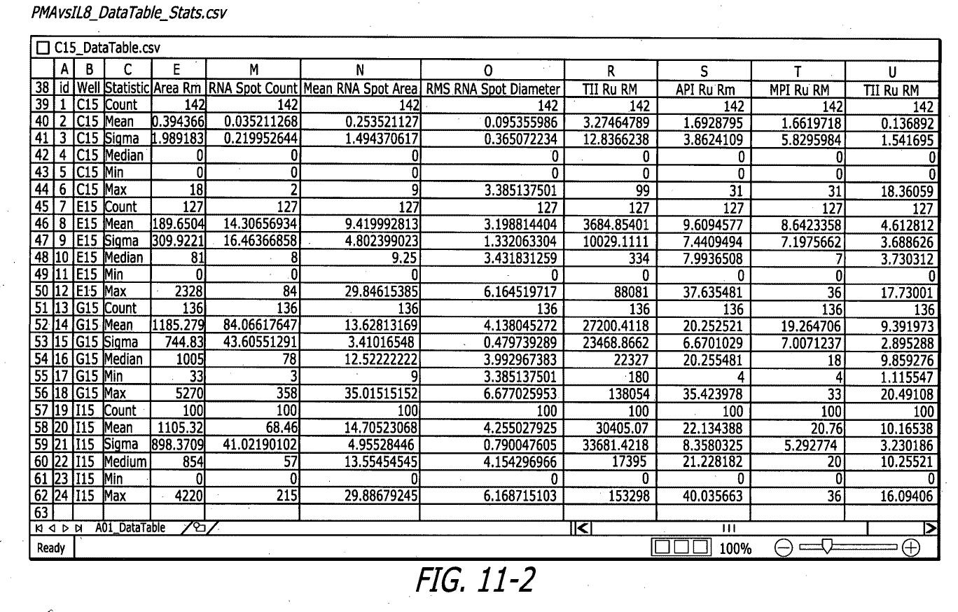

The experimental data provided to the quantitative modeling system may include quantitative data obtained from the images acquired and/or produced by the automated image processing system. For example, refer to FIG. 9, which represents a cell with mRNA according to the assay example described above. In FIG. 9, Nm is the nuclear mask and corresponds to the number of pixels that make up the nuclei. Cm is the cytoplasmic mask, which extends from the cell boundaries to the nucleus. Rm is the RNA mask and corresponds to the number of pixels found within RNA dots for the cell. The automated image processing system obtains quantitative experimental data by from the acquired and/or result images, and places the data into tables such as the table shown in FIG. 8. The examples shown in this table include data obtained from nuclear and loci images discussed above. Nm, which is the size of the nucleus for in units of pixel area, is obtained from an acquired image showing cell nuclei. Area Rm (Area of the RNA mask) represents the total number of pixels identified as corresponding to RNA dots within the RNA image for each cell as per FIG. 8, and is an index of mRNA expression, and will be of considerable interest to the majority of users. Data parameters XLeft Nm, YTop Nm, Width Nm, and Height Nm refer to the x,y location of each nucleus within a nuclear image, and the width and height dimensions, which will assist a user in identifying the location of each cell within a field of view. “IsBoundaryNm” can be either True or False; cells near the boundary of the image (IsBoundaryNm=True) might extend beyond the field of view, and, hence the analysis for RNA expression by may be incomplete. The IsBoundaryNm parameter can be used to sort the cells within Excel, and exclude boundary cells from further analysis, if desired. XCentroid Nm and YCentroid Nm are the x and y coordinates within the image for the center of each nucleus.

Continuing with the description of the data table example of FIG. 8, RNA spot count, Mean RNA Spot Area, and RMS RNA Spot Diameter are useful data parameters relating to RNA expression. RNA spot count is the number of mRNA loci for each cell. Mean RNA Spot Area is the average size of the RNA spots for a particular cell (in units of pixel area). RMS RNA Spot Diameter is an estimate of the mean diameter of the RNA spots in the cell (RMS stands for a Root Mean Square, and refers to the method used to estimate spot diameter). Area×Nm is the area of the nucleus that is NOT also part of the RNA mask; similarly, Area×Cm is the area of the cytoplasmic mask that is NOT also part of the RNA mask. Area×Nm and Area×Cm define the size of the “background” areas within the nucleus and cytoplasm. Advanced users may find these data parameters useful, especially with comparisons to the Area Rm; for example, it might be of interest to calculate: Area Rm/(Area×Nm+Area×Cm+Area Rm), which is the ratio of the area of the RNA spots to the entire area of the cell.

In the example of FIG. 8, Total integrated intensity of the RNA image for the RNA mask is the sum of intensities of the pixels that have been assigned to the RNA mask for each cell (TII Ri Rm—line 22 and column P of the Data Table), is a useful parameter related to mRNA expression. Similarly, the average and median pixel intensities of the RNA image for the RNA mask for the cell are the API Ri Rm, and MPI Ri Rm, respectively. The Standard Deviation of Pixel Intensities for the RNA image RNA mask (SPI Ri Rm) is also reported. This parameter may be of special interest to researchers performing screens of chemical or RNAi libraries involving thousands of samples, as standard deviations of intensity can sometimes be less variable than the means or total integrated intensity measurements.

Finally, in the table of FIG. 8, a series of data parameters are reported that correspond to the background pixel intensities. These include the total integrated, average, and median pixel intensities for the RNA image for pixels within the nuclear mask that are NOT RNA spots (TII Ri×Nm, API Ri×Nm, MPI Ri×Nm, where “X” means NOT RNA spots). The same series of values are also reported for the regions of the cytoplasm that are NOT RNA spots (TII Ri×Cm, API Ri×Cm, MPI Ri×Cm). These data parameters can be used, in combination with the data parameters for the RNA spots to quantify how bright the spots are with regard to the background. For example, differences between API Ri Rm−API Ri×Cm represents the difference in intensity between the RNA spots and the background within the cytoplasmic region. Such differences may be useful parameters to monitor in a screening assay, and, also are likely to be useful for optimization of the assay conditions and imaging parameters for particular samples types.

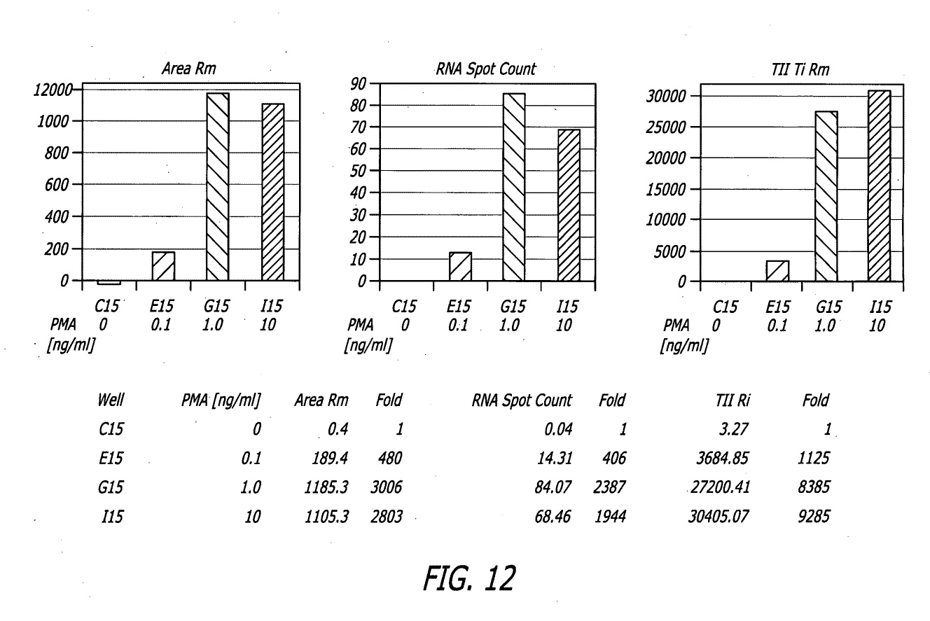

In FIG. 10, two additional data tables useful for managing additional experimental data related to the mRNA example described above are shown. The first part of the data table portion of the C15_DataTable.csv file is shown in the upper panel of FIG. 10; the analogous portion of the G15_DataTable.csv file is shown in the lower panel. For the mRNA experiment, cells in the C15 well of the dish were not exposed to an activator of IL-8 expression. Thus, cells in C15 represent the negative control for the assay. Alternatively, cells in G15 were exposed to 1 ng/ml PMA, a phorbol ester that strongly activates IL-8 expression. For the first 10 cells analyzed for C15, no RNA spots were detected. Thus, there are “0” values in Columns C, K, L, and M, which correspond to the data parameters area of the RNA mask (Area Rm), RNA spot count, and mean RNA spot area, and RNA spot diameter, respectively. Note, also that the first two cells of C15 were boundary cells (IsBoundaryNm=“True”), where as the rest of the cells were judged as being entirely contained within the image (IsBoundaryNm=“False”). Data is reported on a total of 142 cells for well C15 in the C15_DataTable.csv file. In contrast, all of the first 11 cells in the G15 data table featured RNA spots (FIG. 10 lower panel). Thus, there are positive data entries for every line in columns C, K, L, and M. For G15, cell number 8 (Excel line 44), for example, featured 2106 pixels in the RNA mask (column C), an RNA spot count of 148 (column K), a mean RNA spot area of 14.23 pixels (Column L), and an average RMS spot diameter of 4.2565 pixels. Note that data is reported on a total of 136 cells for well C15 in the C15_DataTable.csv file.

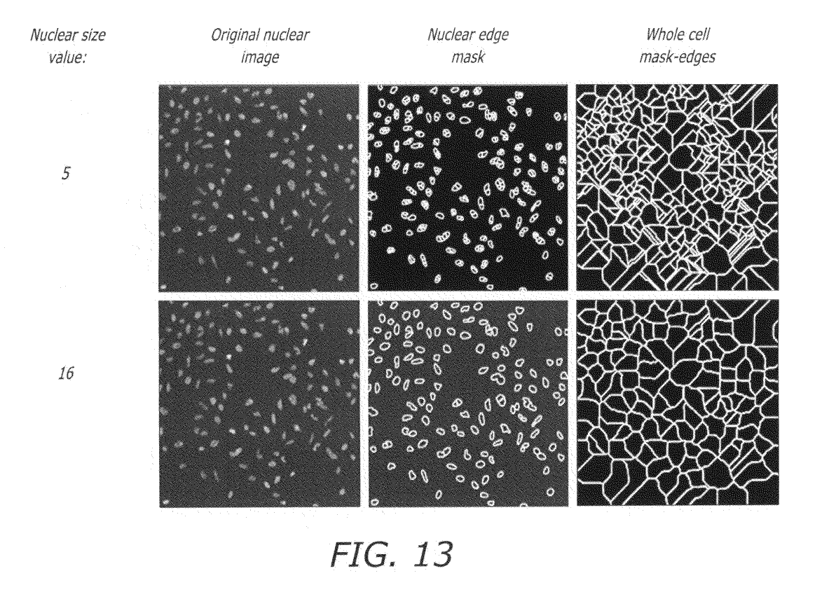

With reference to FIG. 11, portions of the C15_DataTable_Stats.csv (found in the C15 directory) and the PMAvsIL8_DataTable_Stats.csv files (found under the parent directory for the experimental results) are illustrated. The layout of the DataTable_Stats.csv files is related to, but somewhat different than the previously described DataTable.csv files. For example, values in column A are the StatsID numbers. There are 6 useful statistics which are the Count (Row 39 in the C15_DataTableStats.csv file) which is the number of cells that were used in the calculations, the Mean, which is the average value obtained for all cells (the well population) that were analyzed in the well, Sigma, which is the standard deviation for the data parameter and for the well population, Median, which is the value of the data parameter for which 50% of the data values for the well exceeded (and 50% were below), the Min, which is the lowest value obtained, and the Max, which is the maximum value that was obtained. Column B displays the well designation for housekeeping purposes, and Column C displays the “Count”, “Mean”, “Sigma”, “Median”, and “Max” titles. Note that all of the data that is displayed refers to values that were derived on a “per cell” basis. For well C15, 142 cells were identified and the data that is summarized in the DataTable_Stats.csv files includes data derived from all of the cells (including the boundary cells), so the count is 142 for every statistic in the report. The Mean value for the RNA Spot Count for well C15 was 0.03521R for well C15, and a maximum of 2 spots per cell were found for the cell population. Note that the PMAvsIL8_DataTable_Stats.csv file (FIG. 11, lower portion), features the identical display for well C15, along with data obtained from all wells in the experimental analysis. Thus, this file provides a convenient reference, displaying a summary of all the results for the experiment.

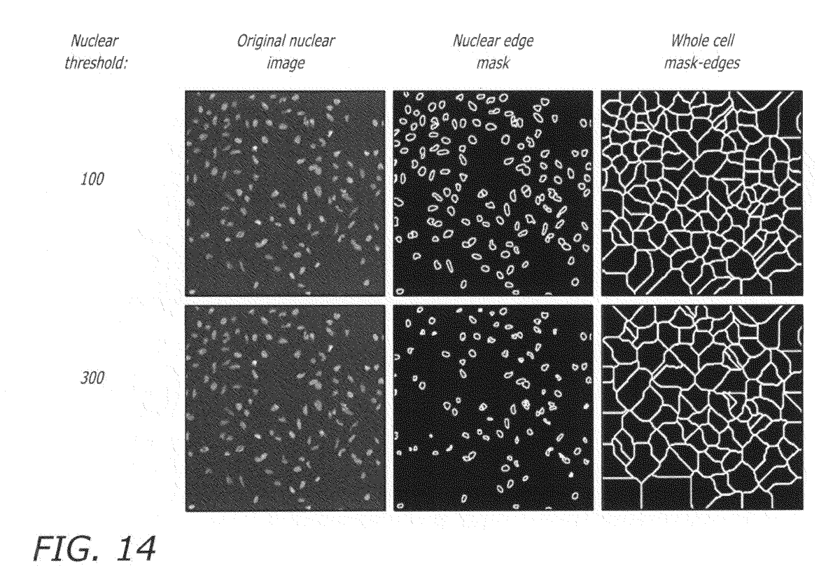

Results for the experiment in which the effect of PMA was tested on IL8 mRNA expression are shown in FIG. 12. Results are graphed and tabulated for 3 key data parameters that describe mRNA expression. Area Rm, the average area, per cell, of the RNA mask was <1 for well C15, but >1100 for well G15. Thus, addition of 1 ng/ml PMA elicited a 3000-fold increase in this parameter. For the RNA spot count, essentially no spots were found for the control well (the average number of spots was approx. 0.04/cell), whereas 14.3 spots/cell were found for cells exposed to 0.1 ng/ml PMA (well E15), and 84.1 spots/cell were found for 1 ng/ml PMA (well G15). Also, note that the TII Ri Rm data parameter, which is the total intensity of the spots/cell, went up by 8000-fold (Table in FIG. 12). Since the assay results in a single RNA spot per mRNA, the RNA Spot Count data parameter may be of interest. Users screening large chemical or siRNA libraries vs. mRNA expression, utilizing automated methodology, may find the Area Rm and TII Ri Rm data parameters of interest, due to the very high dynamic range these parameters may provide for the assay.

### Setting Examples

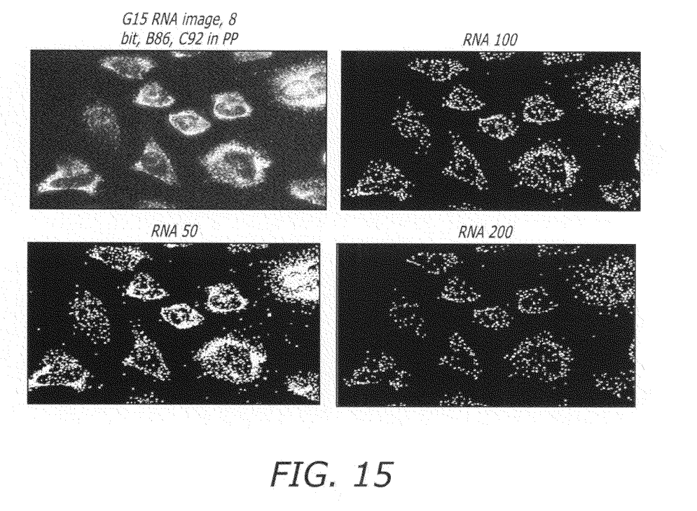

Refer now to FIG. 13 for an understanding of Nuclear Size adjustment using the GUI of FIG. 4. A default setting (Nuclear Size=10, Nuclear Threshold=100, RNA Threshold=100) are appropriate for digital microscopy workstations utilizing 20× objectives, and for images captured with typical digital cameras. While these settings are likely to be very good for most circumstances, a user may run test analyses at various settings, to further optimize the performance of the automated image processing system. To produce optimal data analysis, the automated image processing system should identify the position of each nucleus in the nuclear image for every field of view. To help the system recognize the nuclei of different cell types and at different magnifications, and different overall staining intensities, user-adjustable controls are provided on the user GUI of FIGS. 4 and 5 that are relevant to the nuclear images. These are the expected Nuclear Size, and the Nuclear Threshold settings. In the example of FIG. 4, a number between 1 and 99 can be entered into the Nuclear Size field. These numbers may not correspond to an exact physical dimension of the nucleus, but, instead may be relative. To adjust the nuclear size adjustment for improved results, a user may set the Nuclear Size to 5, with the Nuclear and RNA Thresholds set at 100%, select a well (or slide area) for analysis and run the mRNA image processing algorithm. Next, a new output folder may be created and named, and, with the Nuclear Size set to another value (for example, 16) the algorithm may be run on the same well (or slide area). Images generated by the algorithm of the same well with different Nuclear Size settings are shown side by side in FIG. 13. The Nuclear edge mask shows the boundary circles for the nuclei identified by algorithm processing. For the Nuclear Size 5 analysis, many of the original nuclei are subdivided into two or more circles in the Nuclear edge mask. Thus, Nuclear Size 5 may be too low a value for this cell type and magnification. In this regard, consider the Whole cell mask-edges generated for the size 5 setting, which displays the boundaries of the cells as estimated by the algorithm; many very small shapes are shown that may be too small to represent authentic cells and many cell boundary lines cross nuclei (some are sectioned into 2 or even 4 cells). Consider next the Nuclear edge mask and Whole cell mask-edges images for the analysis with Nuclear Size 16. The Nuclear edge mask image includes single circles at the position of nearly every authentic nuclei in the field of view (lower middle panel, FIG. 13), indicating that the algorithm performed correctly. Furthermore, the cell boundaries are appropriately sized and rarely cross nuclei. Thus, for the particular circumstances of this example, a Nuclear Size of 16 will result in accurate cell counts, and an accurate count of the number of mRNA spots per cell.

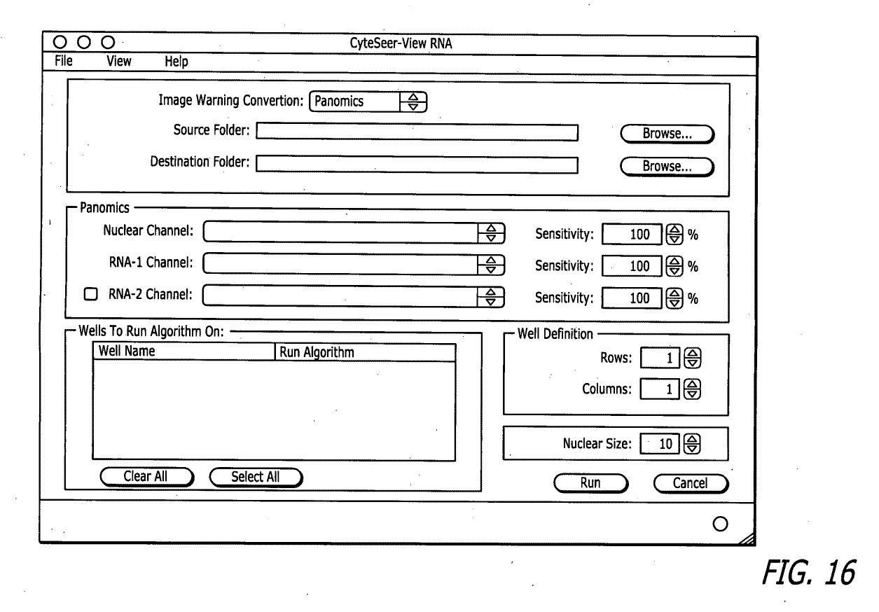

Refer now to FIG. 14 for an understanding of the Nuclear Threshold adjustment using the GUI of FIG. 4. Entry of a lower number may cause the algorithm to recognize dimmer nuclei in the nuclear channel, whereas entry of larger numbers will reduce the sensitivity of the system. To illustrate this principle, the acquired images that resulted in the images in FIG. 13 resulted in the images of FIG. 14, with the Nuclear Size set to 16, RNA Threshold to 100, with Nuclear Threshold settings of 100 and 300. The results indicate that a setting of 300 resulted in many nuclei being missed, indicating greater algorithm accuracy with the lower setting of 100.

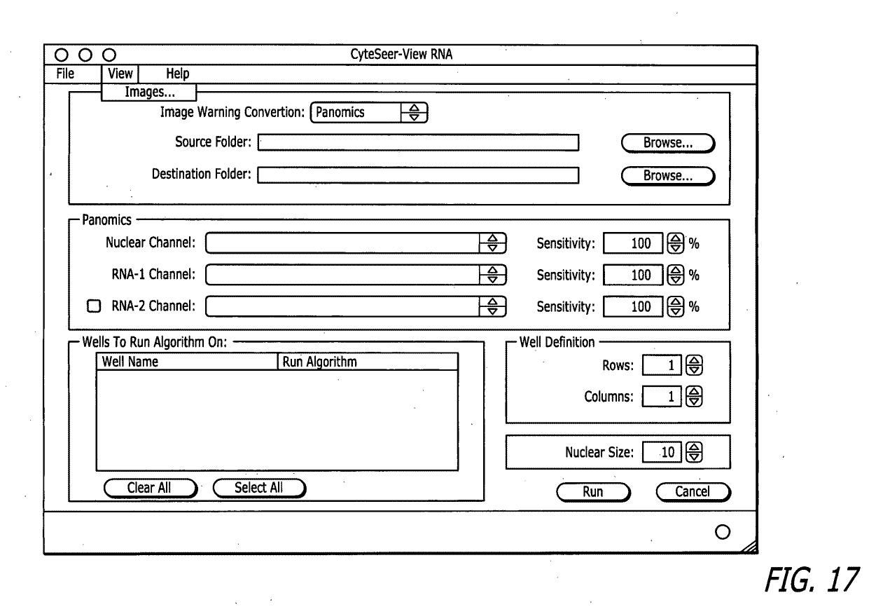

Refer now to FIG. 15 for an understanding of the RNA Threshold adjustment using the GUI of FIG. 4. The ability of the mRNA algorithm to analyze the RNA image may be adjusted by use of the RNA Threshold feature. The smaller the number entered for this parameter, the more spots will be counted by the program. However, the smaller the number that is entered, the greater the risk of also quantifying small image artifacts as authentic RNA spots. Opinions may differ about RNA spot recognition. Careful adjustment of the RNA threshold setting may cause the mRNA algorithm to match what a user may see when looking through a microscope and using any image enhancement tools at hand. Another approach that may be preferred when performing screening assays may be to select RNA threshold parameters that yield the greatest separation between certain experimental conditions. For example, reducing the RNA channel sensitivity (by using a higher RNA threshold number), might diminish the number of “false positives” in a large screen.

### Image Viewer

The operations and functions thus far described are implemented in a cyclic or iterative process. Use of an automated image processing system as an assay tool typically requires a series of steps to determine the best algorithm settings with which to extract and analyze information from processed images. Magnified images are acquired by scanning plates and/or wells by means of a microscope system, which may be automated. The images are processed for analysis, measurements are made of objects in the processed images, and the results obtained by measurement are analyzed. This is a plate-by-plate or well-by-well process of image acquisition, image processing, and measurement that may cycle or iterate one, two, or more times in order to determine and set optimal assay and image processing conditions and parameter values.

It is desirable to be able to view acquired and processed images during iterations of image processing in order to evaluate analysis results by comparison of acquired and processed images so that a user may set, reset, adjust, or otherwise change (hereinafter, “set”) image processing algorithm parameter values. It is also desirable, if not necessary, to be able to view one or more acquired images and images generated by the image processing algorithm in order to evaluate assay results and/or make decisions to set algorithm parameter values. In both regards, it is also desirable to be able to highlight one or more image object features in order to visually emphasize the effects of parameter values on image processing results.

However, access to acquired and processed images can be problematic. Most commercially-available automated image processing systems built for HCS/HTS have a limited capability for viewing either acquired or processed images; and, most of that capability is provided through commercially-available image viewing tools and/or programs that are not adapted for the requirements of HCS/HTS or integrated with the automated image processing systems. Typically, when using a commercially-available automated image processing system to perform assays of biological material, a user must search through acquired images to find an image of interest. Then, if the processed images are not stored with or linked to the acquired images from which they are derived, a further search must be conducted to locate the relevant processed image or images. Further, once an acquired image and its counterpart processed images are located, the image processing system may not provide viewing options that selectively access, retrieve, and view the images, separately, or in selectable combinations, and selectively highlight or emphasize visible structures of the assayed biological material being portrayed.

A solution to the problem of limited access to and use of image information in automated image processing systems built for HCS/HTS is provided in a graphical user interface operable to interact with or on a computer to manage and control execution of an image processing algorithm selected to acquire and process images of biological material in order to selectively view features of the material affected by a biological assay. The graphical user interface includes an image viewer adapted for viewing images acquired by the system (hereinafter, “acquired images”) and images produced, extracted, or otherwise obtained from information in the acquired images by the image processing algorithm (hereinafter, “processed images”).

Preferably, the image viewer is operable to selectively highlight or emphasize objects and features in acquired and/or processed images that correspond to structural components of the biological material being assayed. Preferably, the image viewer is operable to browse for, select, and view acquired and processed images in whole or in part. Preferably, the image viewer is operable to adjust image characteristics such as color and size of objects and other image components such as nuclear edges and interiors and cell outlines. Preferably, the image viewer is operable to select for display indicia based upon information produced by the selected image processing algorithm such as identification marks, bounding boxes, and centroids in processed images. Preferably, the image viewer is operable to select, combine, separate, and otherwise manipulate in these ways acquired and processed images that are linked by a naming convention.

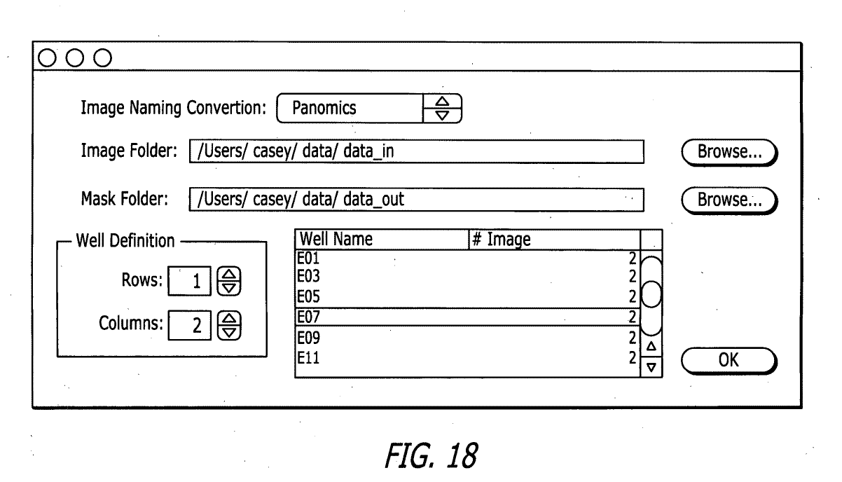

An image viewer is provided by way of an automated image processing system built for HCS/HTS having a graphical user interface operable to interact with or on a computer to manage and control execution of an image processing algorithm selected to acquire and process magnified images of biological material in order to analyze features of the material affected by an assay. Preferably, the image viewer is integrated and operable with a graphical user interface that controls and manages image processing parameters of an automated image processing system built for HCS/HTS. In this regard, the graphical user interface (GUI) 400 of FIG. 4 may be modified as per the GUI 1600 of FIG. 16, which adds to the GUI 400 a third channel definition field (RNA-2 Channel) and a pull-down menu labeled “View”. In addition, the GUI 1600 eliminates the Threshold Factors panel of the GUI 400, and substitutes therefore a scrolled “Sensitivity” setting for each channel.

Each of the scrolled Sensitivity settings in the GUI 1600 is essentially the inverse, but produces essentially the effect, as the corresponding Threshold setting in the GUI 400. In other words, a Sensitivity setting indicates a level of sensitivity to be observed by the selected image processing algorithm for identifying objects in their associated channel.

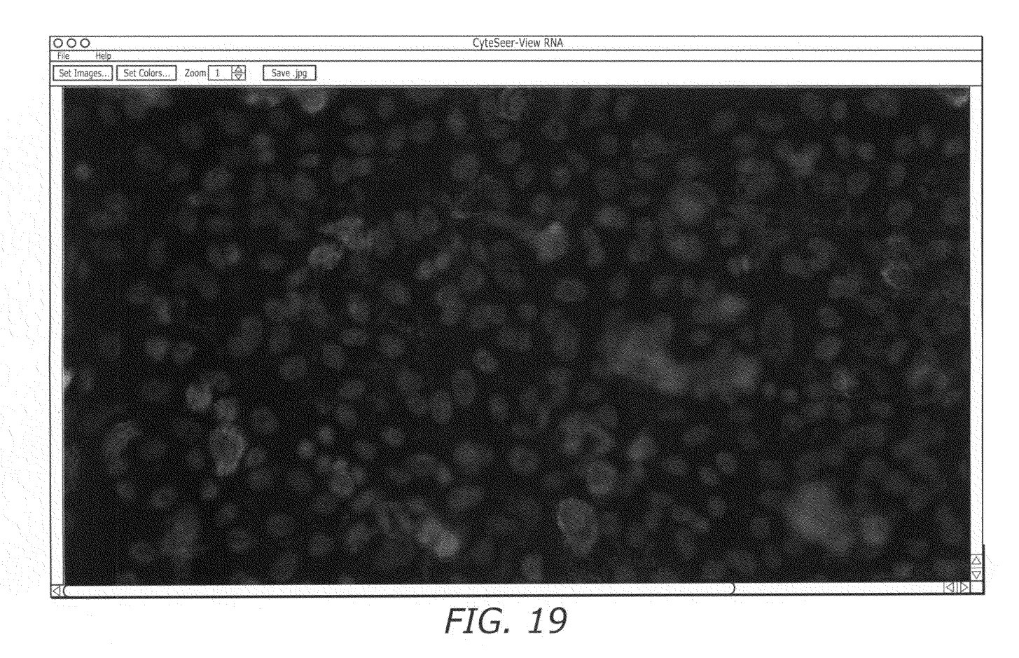

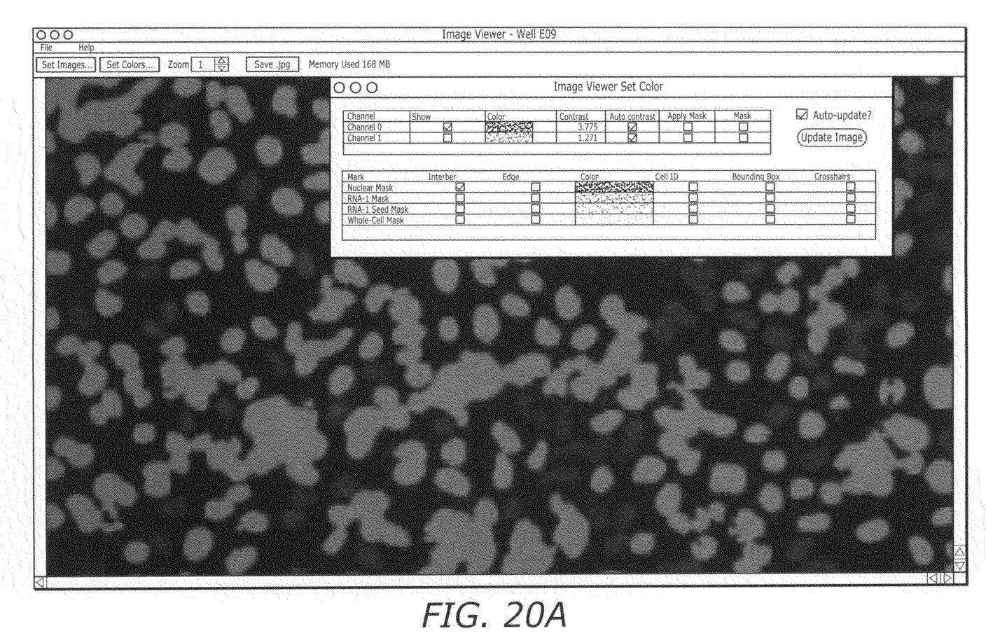

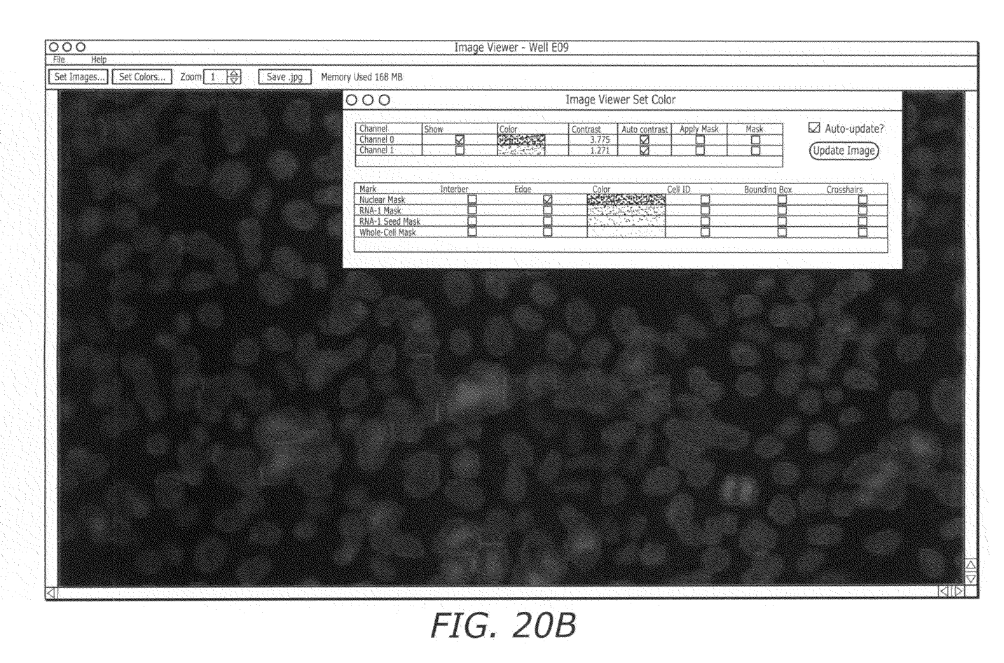

The View pull-down menu includes an Images entry per FIG. 17. Selection of the Images entry launches an interactive image viewer which provides an initial Set Images dialog box per FIG. 18. In the Set Images dialog box of FIG. 18, constraints for searching for and retrieving specific acquired and processed images are received by the image viewer. In this regard, the Set Images dialog box includes a scrolled Image Naming Convention menu that enables selection of an image naming convention. Browse buttons enable the image viewer to browse to Image and Mask Folders containing acquired and processed images, respectively, that satisfy the selected naming convention. (Note that the Image and Mask folders in the Set Images dialog box are, in fact called the Source and Destination folders in the GUIs 400 and 1600). The browsed-to folders are identified in corresponding Image and Mask folder fields. A Well Definition control panel permits entry of well definitions. Stored images satisfying the search constraints (“search results”) are listed by identifying indicia in the Set Images window, for example in a Well Name panel. An image satisfying the search constraints is selected by navigation through the list of search results to highlight a listed image and receipt of a selection indication (such as via the OK button). For example, search results may include an identified acquired image, available from the browsed-to source folder and the processed images linked to it by the naming convention. Selection causes the image viewer to produce a window displaying the selected image. For convenience, this window may be called the “main imager viewer window”; an example is seen in FIG. 19.

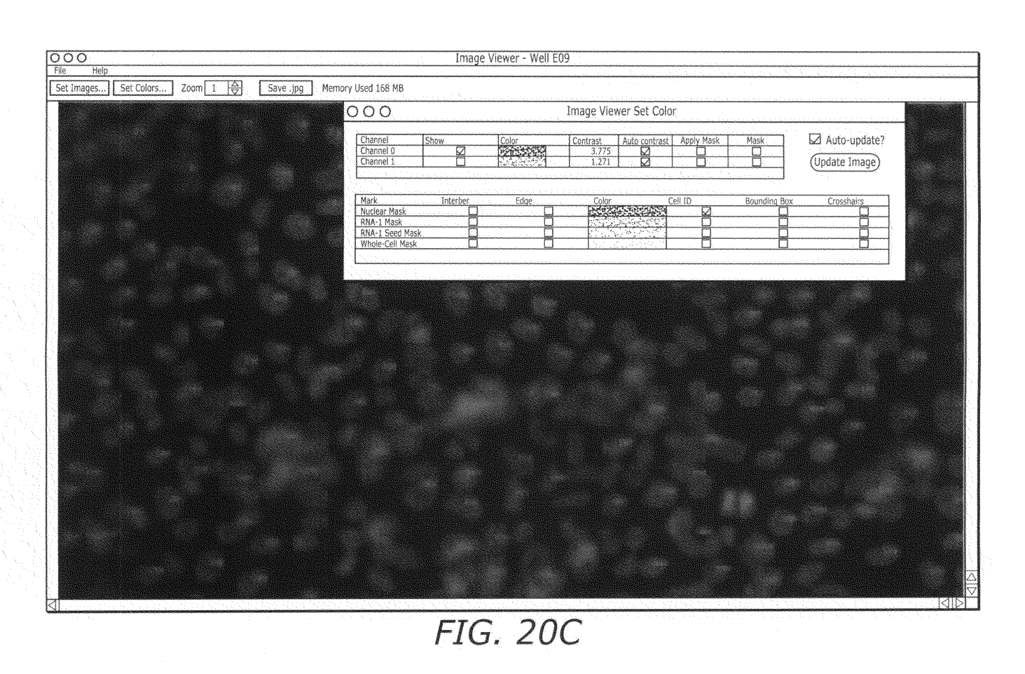

Initially, with use of the image viewer for search and selection of an acquired image for viewing, the selected image is an image providing a magnified view of a specified portion of a biological assay, such as a specimen on a slide or in a well, and thus is an “acquired” image, which is used by the selected image processing algorithm. Another such image may be obtained via the image viewer by use of the Set Image pull down menu. Selection of the Set Colors pull-down menu produces a moveable dialog box by which the grey scale file of the selected acquired image is processed via the image viewer to produce a pseudo-coloring of image objects that enable a user to selectively highlight or emphasize features of the objects that correspond to structural components of the biological material being assayed. With reference to the examples seen in FIGS. 20A-20F, it will be appreciated that the Set Colors dialog box controls what the image viewer displays on the main image viewer window. The acquired, unprocessed image and all processed images related to it are updated as relevant boxes or menu items are selected or deselected and can be kept open while the dialog box is active. This feature provides an effective way of iteratively comparing acquired images with their processed counterparts in order to view how well the image processing algorithm performs, so that decisions can be made about setting parameter values for the algorithm via the GUI 400, 1600 of FIGS. 4 and 16.

The selected image processing algorithm acquires images and creates processed images. In many instances the processed images are masks, although other processed images may also be created. Preferably, the acquired images are grayscale and the masks are binary. For the mRNA transcription example presented above the acquired images are of biological material on a slide or in wells in the wells of an assay tool after being subjected to an mRNA transcription assay. There may, in some instances, be more than one image acquired per well. The image processing algorithm selected for mRNA assay analysis creates at least a nuclear mask and one RNA mask for each acquired image. Preferably, the algorithm also creates a whole cell mask in which every cell identified by the algorithm is shown by an outline of its membrane. The image viewer may also include image processing and display indicia with objects while displaying images. For example, the selected algorithm may identify objects and calculate positional data during image processing; if so, the image viewer may use image processing information used or created by the algorithm to visibly label biological objects during display. For example, the image viewer may display identification, centroid, and bounding box indicia for cells in the whole cell mask.

For every assay, one or more channels are defined. In this regard, a channel corresponds to an object of interest to the selected image processing algorithm in analyzing assay information in an acquired image. For example, in the mRNA example nuclei and mRNA sites are of interest. Each nucleus found by the algorithm indicates the presence and location of a cell and establishes a reference point for determining which mRNA sites are in the cell. Thus, with reference to FIGS. 4 and 15, each GUI enables designation of the nuclear and RNA-1 channels before the selected algorithm is executed. As per FIG. 15, the GUI 1500 allows designation of more than two channels. In respect of the mRNA example presume the nuclear channel is designated as channel 0 and the RNA-1 channel is designated as channel 1.

As per FIG. 20A, the upper menu 2010 of the Set Colors dialog box enables the image viewer to control display of an acquired image by designation of display characteristics for the objects of each designated channel. Preferably, the display characteristics are chosen to permit customized viewing of selected objects in an acquired image. In this example, the display characteristics are Show, color, and contrast. The Show characteristic denotes showing or not showing the objects of a channel in the displayed image. A box is provided to indicate selection of this option for each designated channel in the Show column of the upper menu. The color characteristic denotes the color with which the objects of a channel are presented in the displayed image. A pull down color palette is provided to indicate selection of the color for each designated channel. Selection of any color for one channel causes the palette to offer another color for the other channels. The Contrast characteristic denotes selection of a predetermined contrast with which to present the objects of a channel in the displayed image. A box is provided to indicate selection of this option for each designated channel in the Contrast column of the upper menu.

As per FIG. 20A, the lower menu 2020 of the Set Colors dialog box enables the image viewer to control display of each processed image derived from the acquired image by designation of image objects and display indicia for each processed image. The image viewer is enabled to retrieve these images quickly by virtue of the naming convention linking them to the acquired image. Preferably, the display characteristics are chosen to permit customized viewing of selected objects and/or indicia in a processed image. In this example, the display characteristics are Interior, Edge, and color and the display indicia are Cell ID, Bounding Box, and Crosshairs.

The Interior characteristic denotes showing or not showing the entire object region of a mask. A box is provided to indicate selection of this option for each mask image in the Mask column of the lower menu. For example, selection of the Interior check box of the Nuclear Mask produces the result seen in FIG. 20A, where each nucleus in the nuclear mask is shown in a saturated shade of light blue.

The Edge characteristic denotes showing or not showing just the perimeter of an object region of a mask. A box is provided to indicate selection of this option for each mask image in the Mask column of the lower menu. For example, selection of the Edge check box (and de-selection of the Interior check box) of the Nuclear Mask produces the result seen in FIG. 20B, where the perimeter or outline of each nucleus in the nuclear mask is shown in a saturated shade of light blue.

The color characteristic denotes the color with which the objects of a mask image are presented in the displayed image. A pull down color palette is provided to indicate selection of the color for each processed image.

The Cell ID indicium denotes showing or not showing a unique identification number (ID) given by the selected image processing algorithm to each cell explicitly or implicitly represented in the displayed image. A box is provided to indicate selection of this option for each mask image in the Mask column of the lower menu. For example, selection of the Cell ID check box of the Nuclear Mask produces the result seen in FIG. 20C, where an ID is shown superimposed on each cell in a saturated shade of light blue.

The Bounding Box indicium denotes showing or not showing a bounding box for each object in the displayed image. A box is provided to indicate selection of this option for each mask image in the Mask column of the lower menu. For example, selection of the Bounding Box check box of the Nuclear Mask produces the result seen in FIG. 20D, where a bounding box for each nucleus in the nuclear mask is shown.

The Crosshairs indicium denotes showing or not showing a centroid for each object in the displayed image. A box is provided to indicate selection of this option for each mask image in the Mask column of the lower menu. For example, selection of the Crosshairs check box of the Nuclear Mask produces the result seen in FIG. 20E, where a crosshair symbol overlying a center point of each nucleus in the nuclear mask is shown.

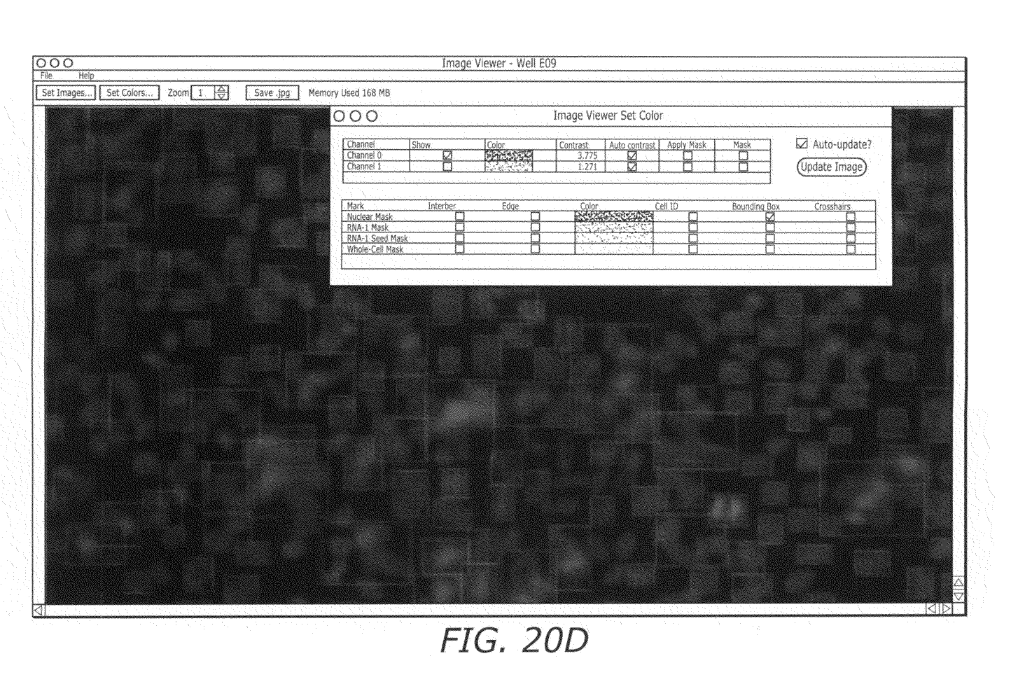

Thus, the image viewer is operable to select acquired and processed images for display and to selectively combine those images in order to highlight and emphasize, and to display, or not display objects, indicia, and other features of those images and their combinations in ways that reveal the performance of the image processing algorithm that produced the processed images. For example, with reference to FIG. 21, both nuclei and transposed mRNA sites of an image acquired in the mRNA example are displayed by selection of the Show check box for both channels in the upper menu of the Set Colors dialog box. The objects are displayed in colors selected in the upper menu. The display also includes objects, colors, and indicia selected for the Nuclear, RNA-1, and Whole Cell masks in the lower menu of the Set Colors dialog box. The mask images, configured by the image viewer according to the lower menu, are combined with the acquired image, configured by the image viewer according to the upper menu, and the combination is displayed as per FIG. 21. As seen, within the outline of cell 327, the smearing of transposed mRNA sites suggests that the value of the sensitivity (or threshold) parameter for the mRNA-1 channel (channel 1) should be adjusted in order to yield greater differentiation between mRNA sites in the mRNA mask. Moreover, it should be evident that the conclusions reached in respect of the value of the nuclear size parameter using three images in FIG. 13 can now be reached using a single composite image produced by the image viewer by combining the three images. Similarly, it should be evident that the conclusions reached in respect of the value of the nuclear sensitivity (or threshold) parameter using three images in FIG. 14 can now be reached using a single composite image produced by the image viewer by combining the three images.

### INDUSTRIAL APPLICATION

A method and system for controlling automated image processing, image data management, and image data analysis operations of HCS and/or HTS systems according the Detailed Description include a graphical user interface (“GUI”) with an image viewer to enable user to designate and view original and processed images and to highlight or visually emphasize visible structures of assayed biological material being portrayed may be implemented in a software program and/or a counterpart processing system. For example, a software program may include a program written in the C++ and/or Java programming languages, and a counterpart processing system may be a general purpose computer system programmed to execute the method. Of course, the method and the programmed computer system may also be embodied in a special purpose processing article provided as a set of one or more chips.

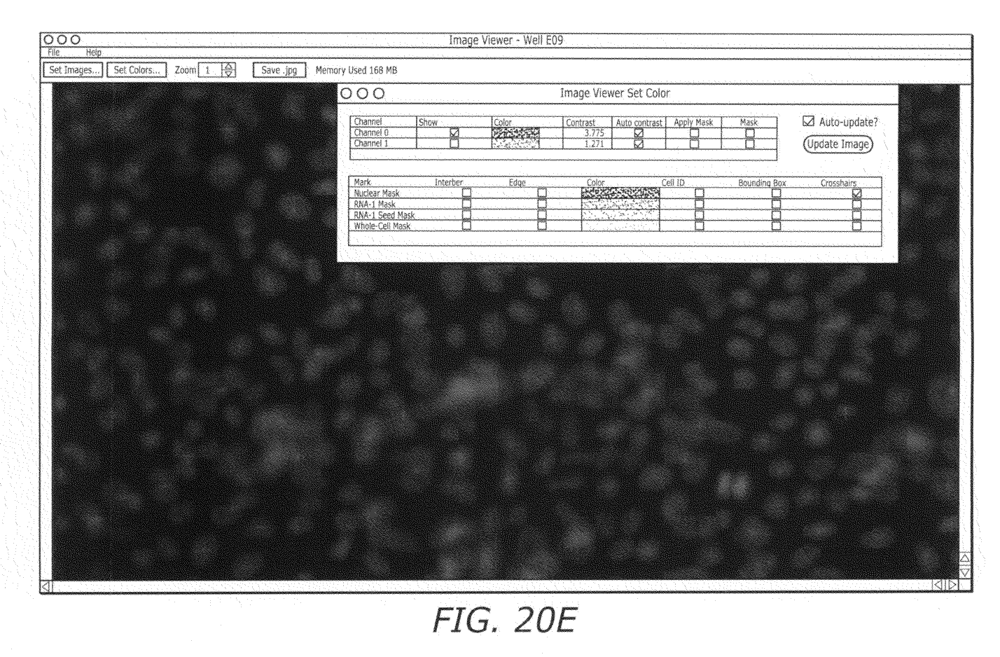

FIG. 22, which is meant for example and not for limitation, illustrates an automated instrumentation system with provision for controlling automated image processing, image data management, and image data analysis operations of HCS and/or HTS systems by way of a graphical user interface (“GUI”) that enables user designation of an image naming convention, image sources and destinations, image processing channels, processing parameter values, and processing spatial designations. For example, the instrumentation system may be, or may reside in, or may be associated with a microscopy system 100 including a microscope 110 with a motorized, automatically moveable stage 112 on which a carrier 116 of biological material may be disposed for observation by way of the microscope 110. The carrier 116 may be a multi-well plate having a plurality of containers called wells disposed in a two dimensional array. For example, and without limitation, the carrier 116 may be a ninety-six well micro-titer plate in each well of which there is biological material that has been cultured, activated, fixed, and stained. A light source 118 provides illumination for operation of the microscope 110 by way of an optical filter 120 and a fiber optic cable 122. The moveable stage 112 may be stationary to obtain a single image, or it may be intermittently or continuously moved to enable the acquisition of a sequence of images. Images observed by the microscope 110 are directed by mirrors and lenses to a high-resolution digital camera 126. The camera 126 obtains and buffers a digital picture of a single image, or obtains and buffers a sequence of digital pictures of a sequence of images. A digital image or a sequence of digital images is transferred from the camera 126 on an interface 127 to a processor 128. The interface 127 may be, for example and without limitation, a universal serial bus (USB). Digital images may be in some standard format that is received as, or converted into, original, magnified images, each composed of an N×M array of pixels by the processor 128. The processor 128 receives one or more original, magnified digital images of biological material and stores the images in image files. The original digital images are processed by the processor 128 and output digital images are provided by the processor 128 for display on an output device with a display 130.

As per FIG. 22, the processor 128 may be a programmed general purpose digital processor having a standard architecture, such as a computer work station. The processor 128 includes a processing unit (CPU) 140 that communicates with a number of peripheral devices by way of a bus subsystem 142. The peripheral devices include a memory subsystem (MEMORY) 144, a file storage subsystem (FILE) 146, user interface devices (USER) 148, an input device (INPUT) 149, and an interface device (INTERFACE) 150. It is not necessary that the processor 28 be connected directly to the microscope 110; it may receive magnified images produced by the microscope from a portable storage device, or by way of a local or wide area network. For example, magnified images obtained by a microscope may be transported to the processor over the internet.

The bus subsystem 142 includes media, devices, ports, protocols, and procedures that enable the processing unit 140 and the peripheral devices 144, 146, 148, 149, and 150 to communicate and transfer data. The bus subsystem 142 provides generally for the processing unit and peripherals to be collocated or dispersed.

The memory subsystem 144 includes read-only memory (ROM) for storage of one or more programs of instructions that implement a number of functions and processes. One of the programs is an automated image process for processing a magnified image of biological material to identify one or more components of an image. The memory subsystem 144 also includes random access memory (RAM) for storing instructions and results during process execution. The RAM is used by the automated image process for storage of images generated as the process executes. The file storage subsystem 146 provides non-volatile storage for program, data, and image files and may include any one or more of a hard drive, floppy drive, CD-ROM, and equivalent devices.

The user interface devices 148 include interface programs and input and output devices supporting a graphical user interface (GUI) for entry of data and commands, initiation and termination of processes and routines and for output of prompts, requests, screens, menus, data, images, and results.

The input device 149 enables the processor 128 to receive digital images directly from the camera 126, or from another source such as a portable storage device, or by way of a local or wide area network. The interface device 150 enables the processor 128 to connect to and communicate with other local or remote processors, computers, servers, clients, nodes and networks. For example, the interface device 150 may provide access to an output device 130 by way of a local or global network 151.

The user interface devices 148 include interface programs and input and output devices supporting a graphical user interface (GUI) for entry of data and commands, initiation and termination of processes and routines and for output of prompts, requests, screens, menus, data, images, and results.

The input device 149 enables the processor 128 to receive digital images directly from the camera 126, or from another source such as a portable storage device, or by way of a local or wide area network. The interface device 150 enables the processor 128 to connect to and communicate with other local or remote processors, computers, servers, clients, nodes and networks. For example, the interface device 150 may provide access to an output device 130 by way of a local or global network 151.

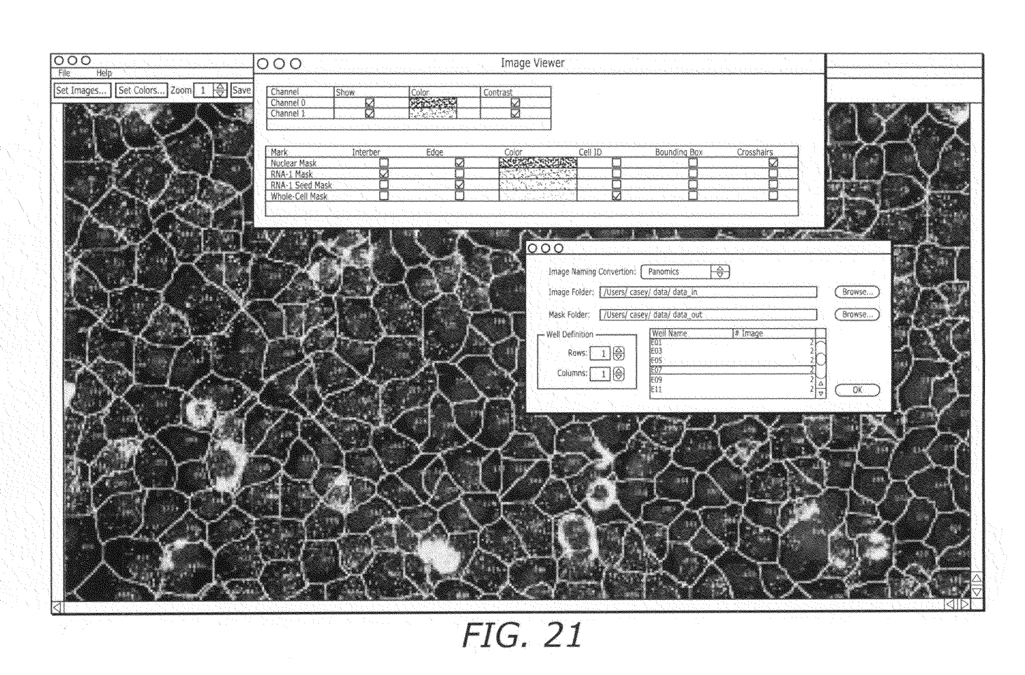

As per FIG. 23 a processing architecture may include a GUI and an image viewer as described. The GUI provides an image analysis control panel as, for example, in FIGS. 4, 5, 16 and 17 to launches an analysis engine to analyze the contents of processed images that are stored in a file system as, for example, that described above. The processed images may include, for example, one or more masks as, for example, in FIGS. 13-15 and 19. An image viewer launched from the GUI as, for example, in FIG. 17 obtains images from the file system. An image viewer control interface as, for example, in FIGS. 18, 20A-20E, and 21, enables a user to establish an image model for display via the image viewer.

The following pseudocode example represents software programming that embodies a method for controlling the automated image processing, image data management, and image data analysis operations of an automated microscopy system, an automated instrumentation system, and/or an image processing and analysis system with a GUI controlling an image viewer. The method enables a user to designate and view original and/or processed images and to highlight or visually emphasize visible structures of biological elements in the images.

### Pseudocode Representation

The following functions handle events from the GUI for various operations:

handleRunAnalysisEvent
{

loadImagesFromFileSystem;
analyzeImagesToMasks;
saveMasksToFileSystem;
measureImagesOnMasks;
saveMeasurementsToFileSystem;

}
handleShowImagesEvent
{

displayImageViewerControlPanel;

}
handleDisplayImageAndMaskEvent
{

loadImagesFromFileSystem;
loadMasksFromFileSystem;
compositeImagesAndMasks;
displayCompositeImageToDisplay;

}

With the method illustrated in the pseudocode representation set out above, a user may utilize image viewer GUI controls described in the Detailed Description and illustrated the Drawings to select various display options. Such display options may include, for example, the following:

1) Select source folder for images
2) Select source folder for masks
3) Designate a naming convention used for the images
4) Designate a number of images across to be sewed together
5) Designate a number of images down to be sewed together
6) Select a menu to set the level of zoom for the image display
Furthermore, for each image channel, the user may:
a) Operate a checkbox to display or not display the channel
b) Operate a menu to set the color of the channel
c) Operate a checkbox to use auto-contrast for the channel
d) Operate a checkbox to apply a mask to the channel
e) Operate a menu to select which mask to apply to the channel
   And, for each mask, the user may:
a) Operate a checkbox to display or not display mask component interiors
b) Operate a checkbox to display or not display mask component edges
c) Operate a menu to set the color of the mask
d) Operate a checkbox to display or not display mask component IDs
e) Operate a checkbox to display or not display mask component bounding boxes
f) Operate a checkbox to display or not display mask component crosshairs

Using the pseudocode example, a software program may be written in the C++ and/or Java programming languages, and incorporated into a software program used to configure a processing system. Such a software program may be embodied as a program product constituted of a program of computer or software instructions or steps stored on a tangible article of manufacture that causes a processor to execute the method. The tangible article of manufacture may be constituted of one or more real and/or virtual data storage articles, and apparatuses for practicing the teachings of this specification may be constituted in whole or in part of a program product with a computer-readable storage medium, network, and/or node that enables a computer, a processor, a fixed or scalable set of resources, a network service, or any equivalent programmable real and/or virtual entity to execute a GUI as described and illustrated above. The program product may include a portable medium suitable for temporarily or permanently storing a program of software instructions that may be read, compiled and executed by a computer, a processor, or any equivalent article. For example, the program product may include a portable programmed device such as the CD such as is seen in FIG. 23, or a network-accessible site, node, center, or any equivalent article.

Although one or more inventions have been described with reference to specifically described embodiments, it should be understood that modifications can be made without departing from the spirit of the one or more inventions. Accordingly, the scope of patent protection is limited only by the following claims.

1. A user interface method for controlling automated processing of images acquired from a sample of biological material, including processor-executed steps comprising:
displaying a graphical user interface;
receiving via the graphical user interface an image viewer selection from a pull-down menu;
receiving via an image viewer graphical user interface a designation of mask image sources;
receiving via the image viewer interface a designation of at least one mask image contained in at least one designated mask image source; and,
displaying the at least one mask image;
the mask image including a first mask image with masks representing positions of a first component in the image.

2. The user interface method of claim 1, wherein the first component is a cell nucleus.

3. The user interface method of claim 2, wherein displaying the at least one mask image includes displaying nuclear mask peripheries with nuclear mask interiors.

4. The user interface method of claim 2, wherein displaying the at least one mask image includes displaying nuclear mask peripheries without nuclear mask interiors.

5. The user interface method of claim 2, wherein displaying the at least one mask image includes displaying nuclear masks and a unique identification with each nuclear mask.

6. The user interface method of claim 2, wherein displaying the at least one mask image includes displaying nuclear masks and a bounding box with each nuclear mask.

7. The user interface method of claim 2, wherein displaying the at least one mask image includes displaying nuclear masks and a centroid with each nuclear mask.

8. The user interface method of claim 1, wherein the first component is transcribed RNA.

9. The user interface method of claim 8, wherein displaying the at least one mask image includes displaying RNA mask peripheries with mask interiors or without mask interiors.

10. The user interface method of claim 8, wherein displaying the at least one mask image includes displaying RNA masks and at least one of a unique identification with each mask, a bounding box with each mask, and a centroid with each mask.

11. A user interface method for controlling automated processing of images acquired from a sample of biological material, including processor-executed steps comprising:
displaying a graphical user interface;
receiving via the graphical user interface a designation of image sources and destinations;
receiving via the graphical user interface a designation of at least one image processing channel corresponding to a respective image component;
storing at the designated image destinations mask images generated from by an automated image process from images stored at the designated image sources;
receiving via the graphical user interface an image viewer selection from a pull-down menu;
receiving via the image viewer interface a designation of an acquired image contained in at least one designated image source; and,
displaying a composite image constituted of the acquired image and at least one mask produced from the acquired image; and,
coloring an object in the composite image that exhibits an effect produced by an processing parameter value.

12. The user interface method of claim 11, wherein receiving designation of at least one image processing channel includes receiving designation of a first dye.

13. The user interface method of claim 12, wherein the first dye is a nuclear stain.

14. The user interface method of claim 12, wherein the first dye is an RNA stain.

15. The user interface method of claim 11, wherein receiving designation of at least one first image processing channel includes receiving designation of a first dye corresponding to a first image processing channel and a second dye corresponding to a second image processing channel.

16. The user interface method of claim 15, wherein the first dye is a nuclear stain.

17. The user interface method of claim 16, wherein the second dye is an RNA stain.

18. The user interface method of claim 15, wherein the first component is a cell nucleus.

19. The user interface method of claim 12, wherein displaying the composite image includes displaying mask peripheries with mask interiors or without mask interiors.

20. The user interface method of claim 12, wherein displaying the composite image includes displaying masks and at least one of a unique identification with each mask, a bounding box with each mask, and a centroid with each mask.
